(19) United States
(12) Patent Application Publication
(10) Pub. No.: US 2006/0053920 A1
(43) Pub. Date: Mar. 16, 2006

(54) Actuator device

(75) Inventors: Yuji Kawamura, Kanagawa (JP); Ikuo Nakamura, Kanagawa (JP); Makito Kawamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Jidosha Denki Kogyo Co., Ltd., Yokohama-shi (JP)

(21) Appl. No.: 11/211,076

(22) Filed: Aug. 25, 2005

(30) Foreign Application Priority Data
Aug. 26, 2004 (JP) P. 2004-247001

(51) Int. Cl. F16H 1/16

(52) U.S. Cl. 74/425

(57) ABSTRACT

The actuator device includes: a motor housed in a case having a cover; an output gear driven to rotate by the drive shaft of via a deceleration gear; an output shaft rotatably supported by the case and rotating together with the output gear; and an output cam mounted on the output shaft; the actuator device having a receiving recessed part accommodating a stopper element on the top surface of the output gear, a stopper element rotatably mounted on the output shaft facing inside the receiving recessed part, and a locking projection part that is locked to and separated from the projection part of the output shaft and a stopper on the stopper element; and stopper where each stopper of the stopper element is locked to the inner surface of the cover to limit the rotation angle of the output gear.

### BACKGROUND OF THE INVENTION

The present application claims foreign priority based on Japanese Patent Application No. 2004-247001 filed on Aug. 26, 2004, the content of which is incorporated herein by reference in its entirety, and concurrently with the filing of this patent application.

The present invention relates to an actuator device preferably used for example in a steering lock device for locking/unlocking the steering shaft of a vehicle.

A steering lock device as a related art actuator device includes: a case having a cover that covers a motor housing unit and a gear housing unit; a motor housed in the motor housing unit of the case; an output gear rotatably housed in the gear housing unit of the case, the output gear driven to rotate via a deceleration gear by the driving shaft of the motor; an output shaft penetrated by and fixed to the shaft of the output gear and rotating together with the output gear; an output cam mounted on the output shaft for locking/unlocking the steering shaft; and a pair of limit switches arranged in the gear housing unit of the case that is turned on/off by a cam part integrally formed on the shaft of the output gear.

On the top surface is provided a projection that is brought into contact with and locked to a projection extending from the inner surface of the cover. When the projection of the output gear is brought into contact with and locked to the projection of the cover, the cam part of the shaft of the output gear turns on the limit switch thus turning off the energization of the motor. In order to absorb the load at the contact locking of the projection of the output gear to the projection of the cover, an elastic element is mounted on the projection of the cover.

JP-A-2002-205622

JP-A-2002-326559

In the related art steering lock device, when the projection of the output gear is brought into contact with and locked to the projection of the cover, a heavy load is applied to the projection of the cover to let the cover float, which is likely to cause deformation or breakage of the cover. Deformation of the cover could fail to limit the rotation angle of the output gear thus causing the gear to rotate by an excessive angle. In order to cope with this problem, an elastic element is mounted on the projection of the cover to absorb possible impact (load) at the contact locking of the projection of the output gear to the projection of the cover. The elastic element on the projection of the cover adds to the number of parts, which leads to an increased cost.

### SUMMARY OF THE INVENTION

The invention is accomplished in order to solve the problems. An object of the invention is to provide a low-cost actuator device capable of reliably preventing deformation and breakage of the cover and reliably rotating the output gear within a predetermined angle and stopping the same on any occasion.

According to a first aspect of the invention, there is provided with an actuator device including:
a case having a cover that covers a motor housing unit and a gear housing unit;
a motor housed in the motor housing unit of the case;
an output gear rotatably housed in the gear housing unit of the case, the output gear driven to rotate via a deceleration gear by the driving shaft of the motor;
an output shaft rotatably supported by the case and rotating together with the output gear; and
an output member mounted on the output shaft;
a stopper element rotatably mounted on the output shaft;
a stopper where the stopper element is locked to the inner surface of the cover to limit the rotation angle of the output gear;
a receiving recessed part for receiving the stopper element formed on the top surface of the output gear; and
a projection formed on the output shaft facing the inside of the receiving recessed part, wherein
the stopper element is respectively provided with a locking projection part that is locked to and separated from the projection of the output shaft and at least a pair of stoppers, and
at least a pair of stoppers are provided on the inner surface of the cover where each stopper of the stopper element is brought into contact with and locked to the output gear in order to limit the rotation angle of the output gear.

According to a second aspect of the invention, there is provided with the actuator device according to the first aspect, wherein
the stopper element is formed in the shape of an approximate disc having a cylindrical part in the center thereof,
the locking projection part is integrally protruded above the inner peripheral surface of the cylindrical part of the stopper, and
at least the pair of stoppers is integrally protruded above the top surface of the stopper element.

As mentioned above, according to the first aspect of the invention, a receiving recessed part for receiving the stopper element is formed on the top surface of the output gear and a projection is formed on the output shaft facing the inside of the receiving recessed part and the stopper element is respectively provided with a locking projection part that is locked to and separated from the projection of the output shaft and at least a pair of stoppers, and at least a pair of stoppers are provided on the inner surface of the cover where each stopper of the stopper element is brought into contact with and locked to the output gear in order to limit the rotation angle of the output gear. This configuration comes into contact with at least a pair of stoppers of the stopper element to at least a pair of stoppers of the cover for reliable locking and rotates the output gear within a predetermined angle and stops the same on any occasion. With this configuration, it is possible to disperse by half the impact (load) at the contact locking of each stopper of the stopper element and each stopper on the inner surface of the cover, compared with a case where a single projection is provided on each of the output gear and the cover as in the related art. This reliably prevents possible deformation and breakage of the cover. Unlike the relate art practices, it is not necessary to mount a load-absorbing elastic element on the projection of the cover, thereby reducing the number of parts required as well as the overall cost. It is possible to accommodate each stopper of the stopper element and each stopper of the cover within the receiving recessed part of the output gear. This implements a stopper structure having certain strength within the small-space receiving recessed part of the output gear while securing the operation angle and capacity of the stopper of the stopper element. This provides a more compact and lower-profile actuator device.

According to the second aspect of the invention, a locking projection part is integrally protruded above the inner peripheral surface of the cylindrical part of the stopper element in the shape of an approximate disc having the cylindrical part in its center and at least a pair of stoppers is integrally protruded above the top surface of the stopper element. This reliably absorbs the impact (load) at the contact locking of each stopper of the stopper element accommodated in the receiving recessed part of the output gear and each stopper on the inner surface of the cover, in balance between each stopper of the stopper element and each stopper on the inner surface of the cover. This reliably suppresses deformation of the cover such as warpage and reliably rotates the output gear within a predetermined angle and stopping the same on any occasion.

### BRIEF DESCRIPTION OF THE DRAWINGS

FIG. 1 is an exploded perspective view of a steering lock device according to Embodiment 1 of the invention;

FIG. 2 is a plan view of the steering lock device;

FIG. 3 is a bottom view of the steering lock device;

FIG. 4 is a perspective view of the steering lock device seen from the bottom;

FIG. 5 is a rear view of the steering lock device;

FIG. 6 is a plan view of the inside of the case of the steering lock device;

FIG. 7 is a cross section taken along line X-X of FIG. 2;

FIG. 8 is a side view of a motor used in the steering lock device;

FIG. 9 is a plan view of the motor;

FIG. 10A is a rear view of a cylindrical elastic member attached to the motor;

FIG. 10B is a side view of the elastic member;

FIG. 10C is a plan view of the elastic member;

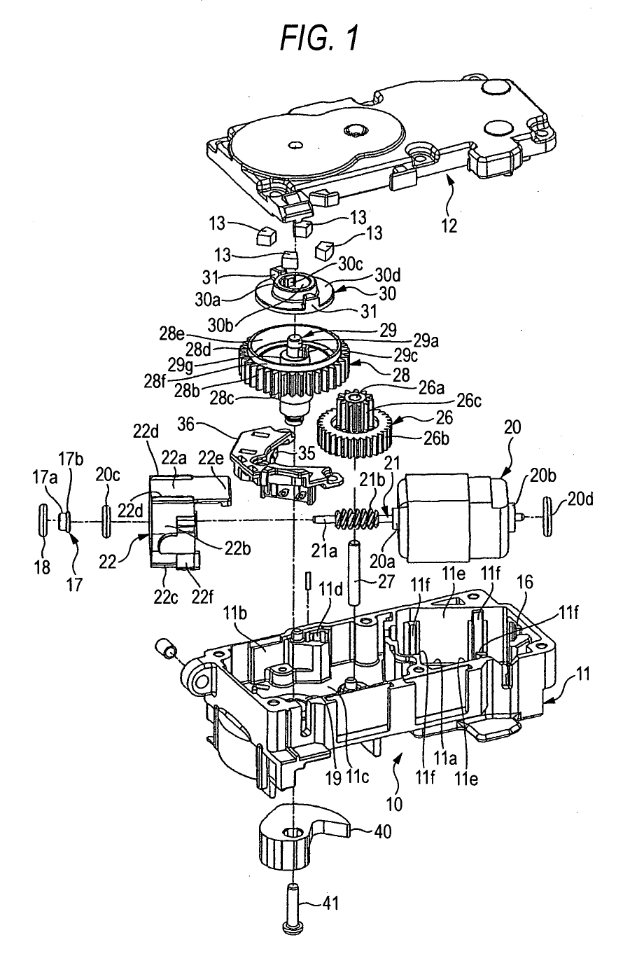

FIG. 1A is an enlarged cross section showing the terminal connecting part of the motor;

FIG. 11B is an enlarged cross section showing a state where a terminal is connected to the terminal connecting part;

FIG. 11C is a partial plan view of the motor with the terminal connected;

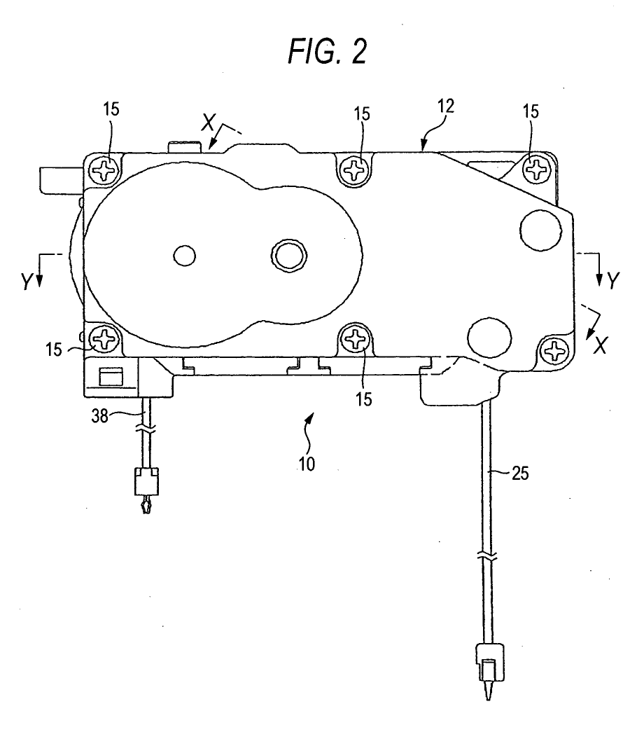

FIG. 12 is a cross section taken along line Y-Y of FIG. 2;

FIG. 13 is an enlarged cross section of the Z part in FIG. 12;

FIG. 14A illustrates the relationship between an output shaft and a stopper element used in the steering lock device and the stopper of the cover;

FIG. 14B is a cross section taken along line P-P of FIG. 14A;

FIG. 15A is across section of the tip of the output shaft;

FIG. 15B is a side view of the tip of the output shaft;

FIG. 16A is a plan view of the stopper element;

FIG. 16B is a cross section taken along line Q-Q of FIG. 16A;

FIG. 17A is a bottom view of the main part of the cover;

FIG. 17B is a cross section taken along line R-R of FIG. 17A;

FIG. 18A is a side view of the lower end of the output shaft;

FIG. 18B is a bottom view of the lower end of the output shaft;

FIG. 19A illustrates a state just before the output shaft starts to rotate;

FIG. 19B illustrates a state before one limit switch is operated in the state of FIG. 19A;

FIG. 20A illustrates a state where the output shaft has rotated by a predetermined angle;

FIG. 20B illustrates a state just before one limit switch is turned ON in the state of FIG. 20A;

FIG. 21A illustrates a state just before the projection part of the output shaft is brought into contact with the locking projection part of the stopper element;

FIG. 21B illustrates the ON state of one limit switch in the state of FIG. 21A;

FIG. 22A illustrates a state where the projection part of the output shaft is brought into contact with the locking projection part of the stopper element;

FIG. 22B illustrates the operating state of one limit switch in the state of FIG. 22A;

FIG. 23A illustrates a state where the projection part of the output shaft has pushed the locking projection part of the stopper element; and

FIG. 23B illustrates the operating state of one limit switch in the state of FIG. 23A.

### DETAILED DESCRIPTION OF THE PREFERRED EMBODIMENTS

Embodiment 1 of the invention will be described referring to drawings.

### Embodiment 1

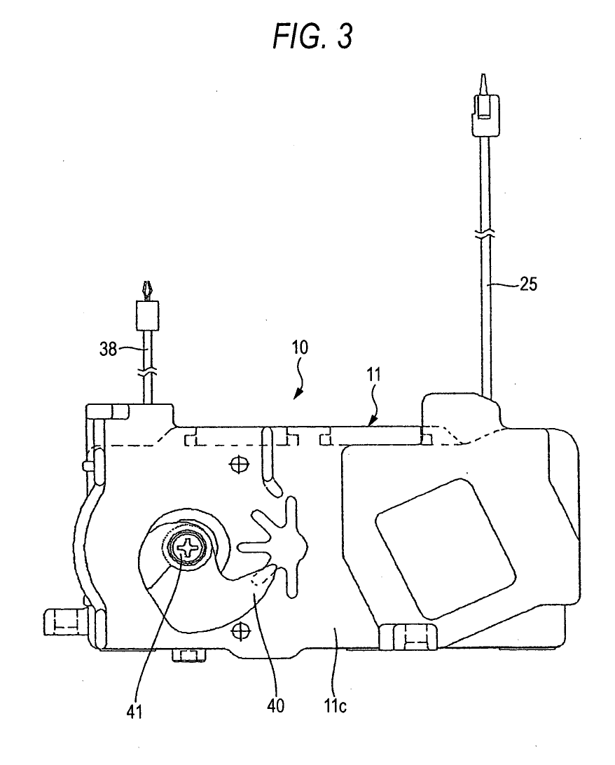

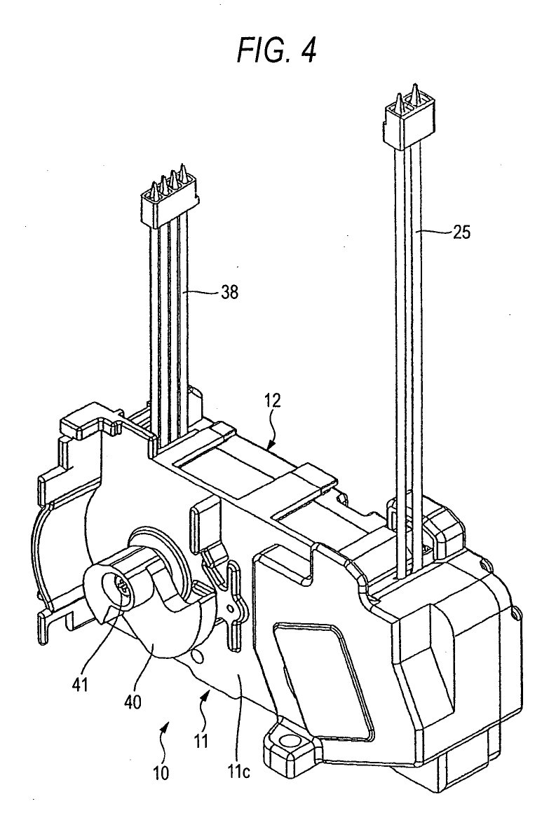

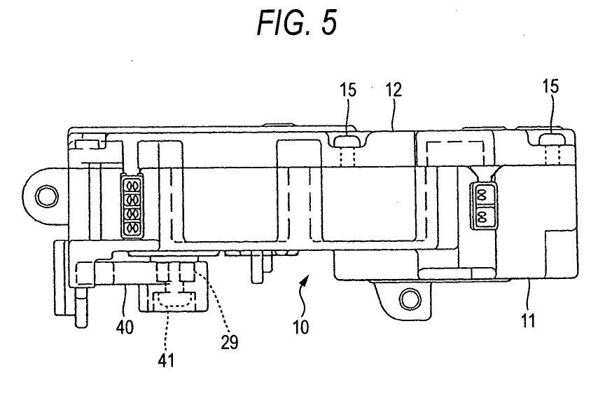

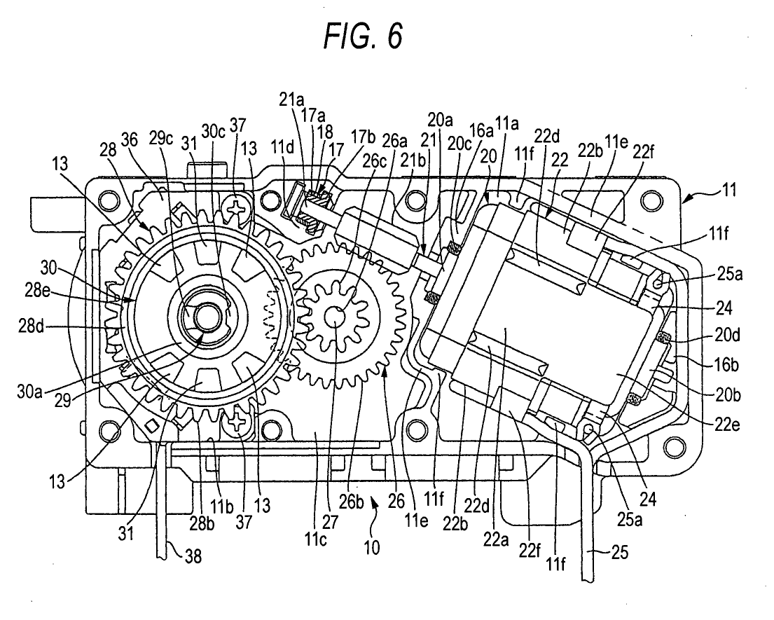

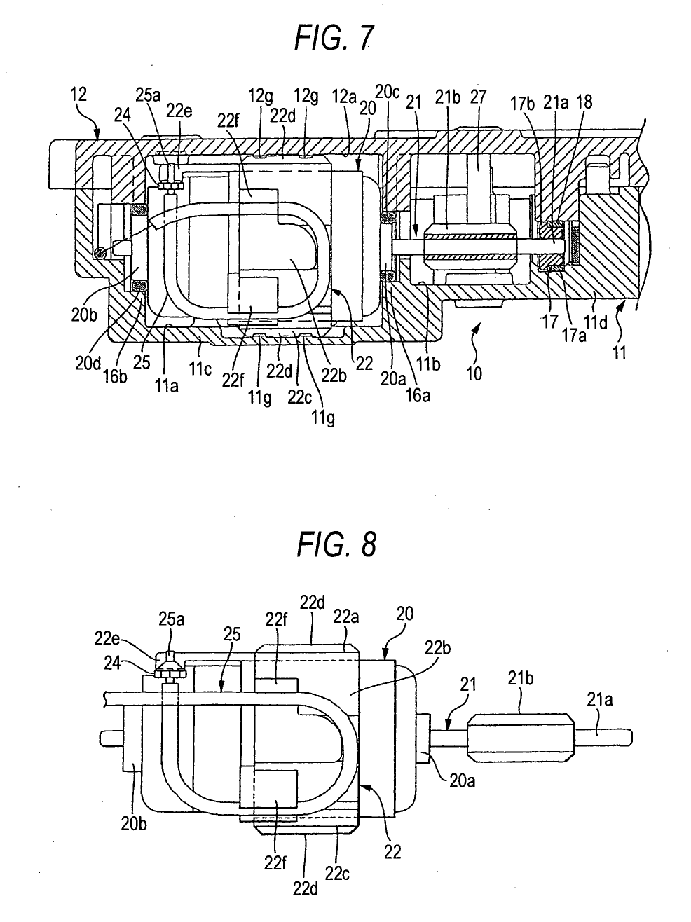

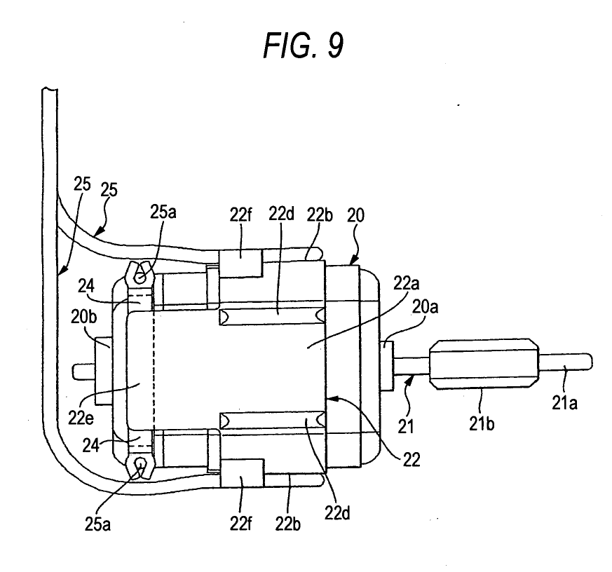

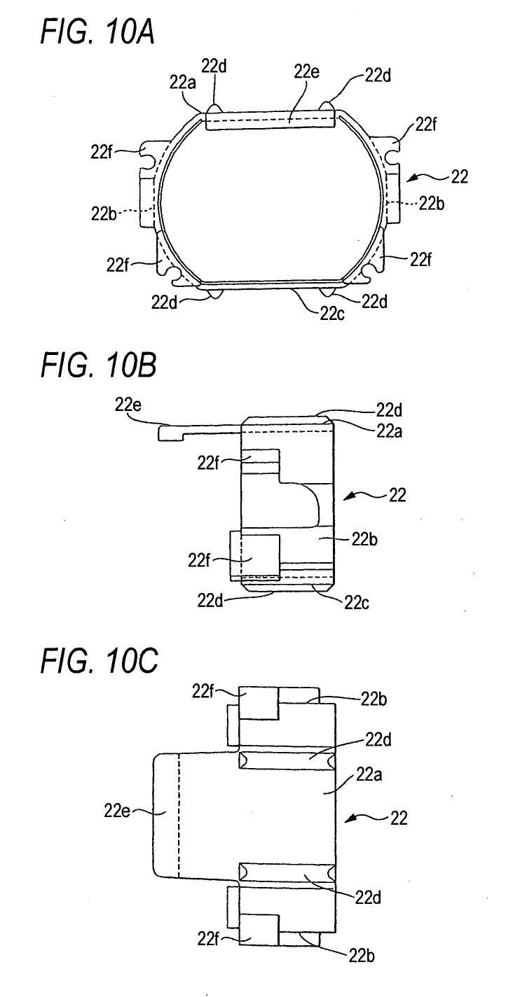

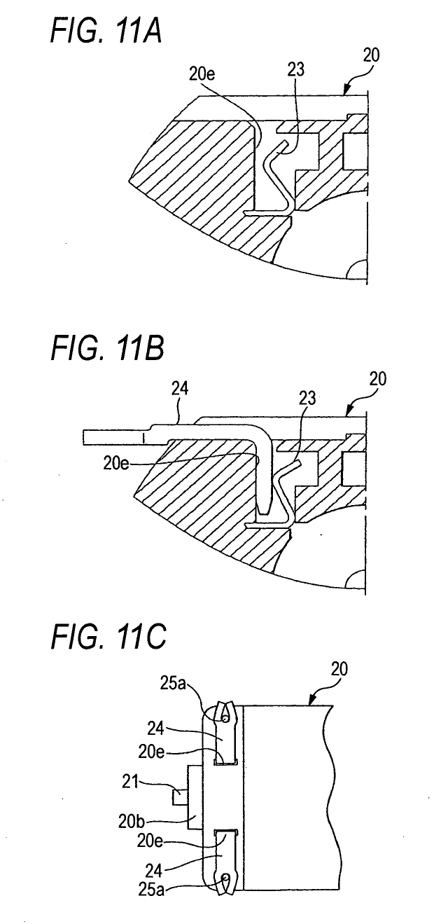

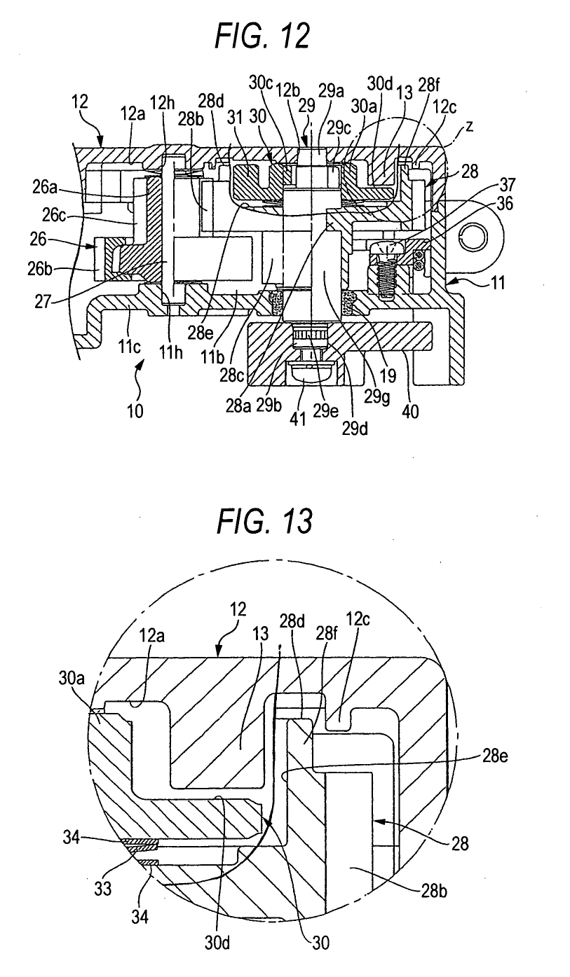

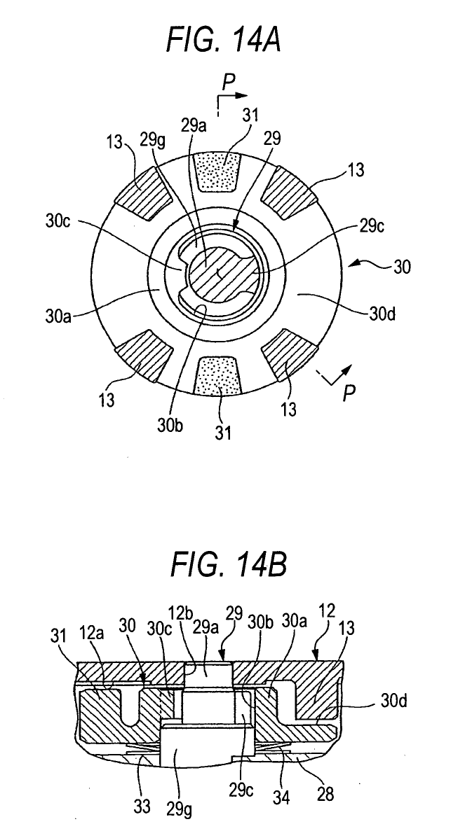

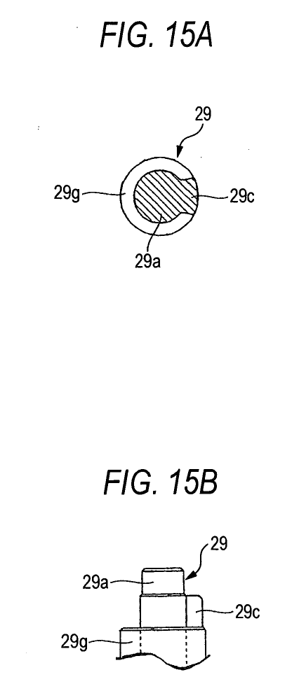

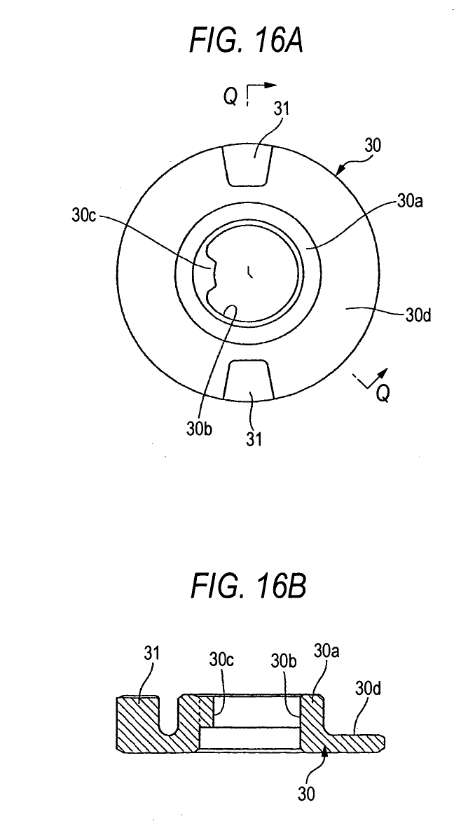

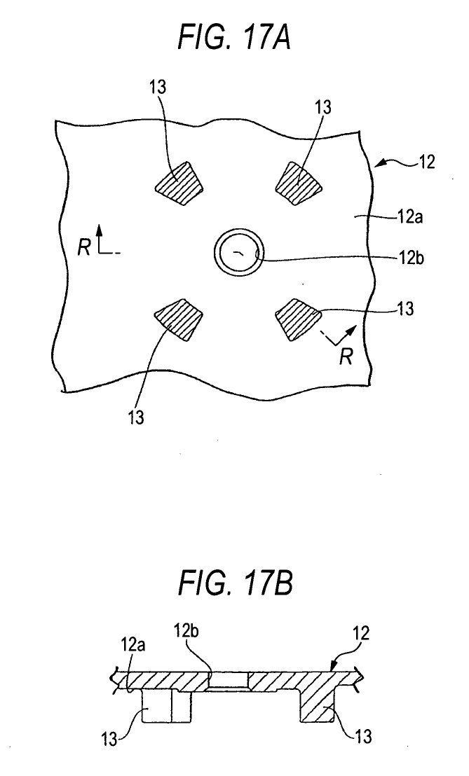

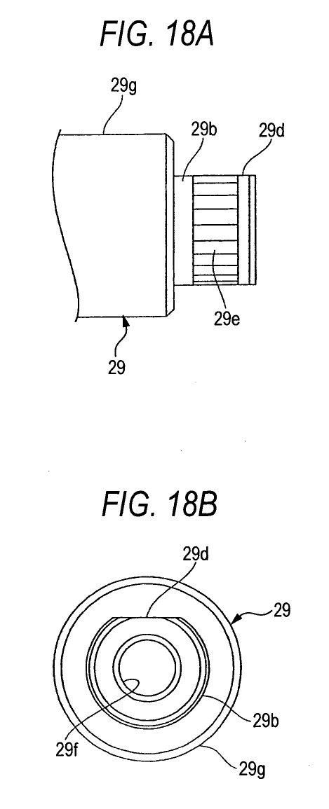

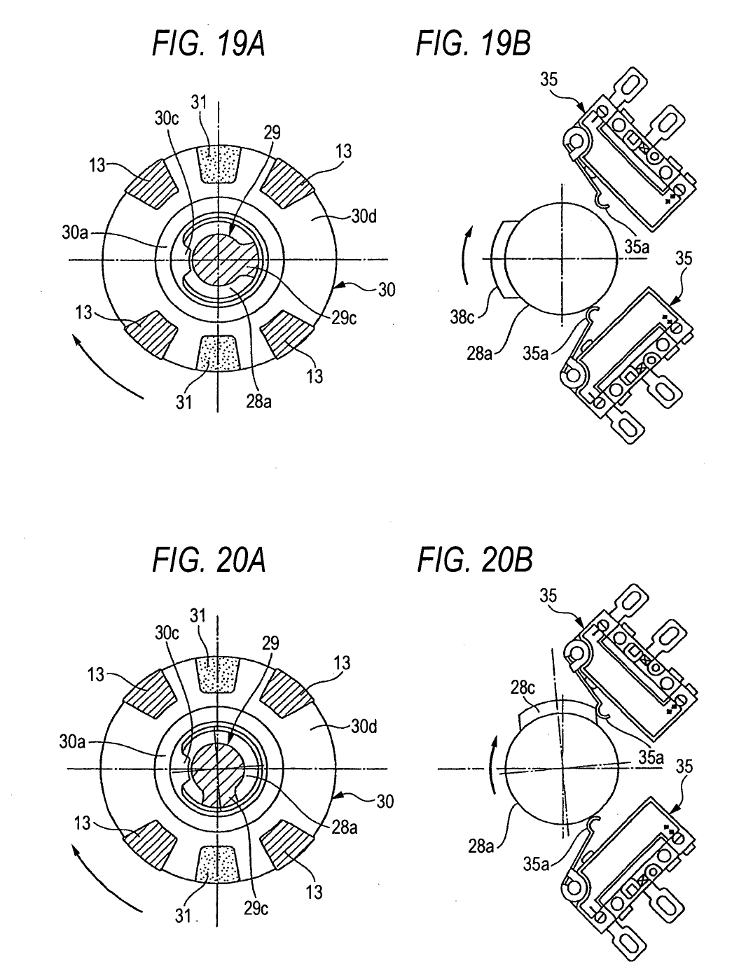

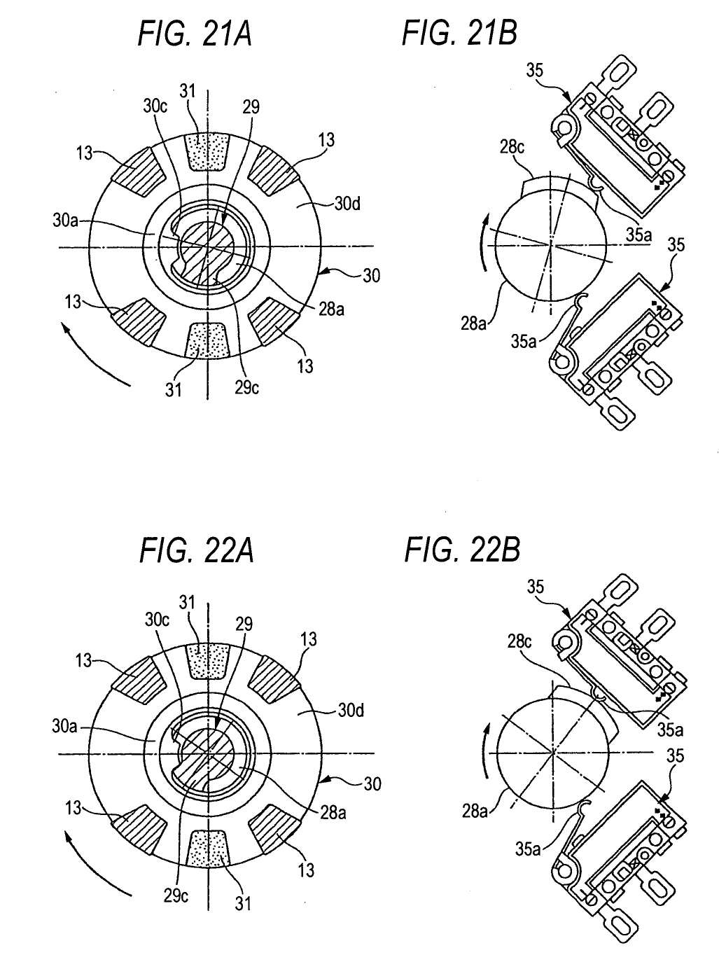

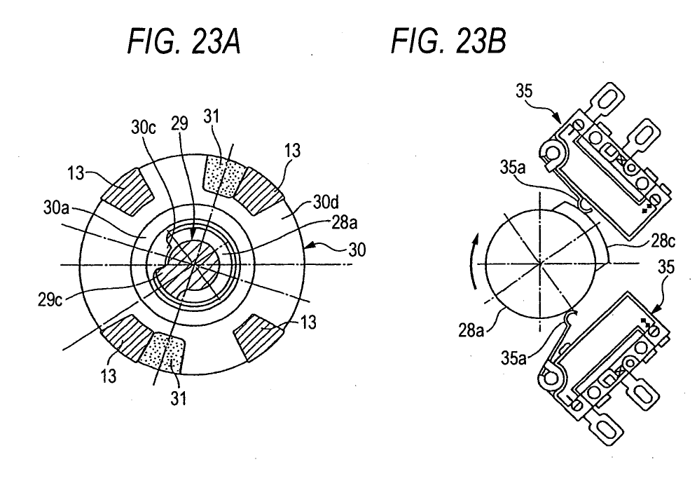

FIG. 1 is an exploded perspective view of a steering lock device according to Embodiment 1 of the invention. FIG. 2 is a plan view of the steering lock device. FIG. 3 is a bottom view of the steering lock device. FIG. 4 is a perspective view of the steering lock device seen from the bottom. FIG. 5 is a rear view of the steering lock device. FIG. 6 is a plan view of the inside of the case of the steering lock device. FIG. 7 is a cross section cross section taken along line X-X of FIG. 2. FIG. 8 is a side view of a motor used in the steering lock device. FIG. 9 is a plan view of the motor. FIG. 10A is a rear view of a cylindrical elastic member attached to the motor. FIG. 10B is a side view of the elastic member. FIG. 10C is a plan view of the elastic member. FIG. 11A is an enlarged cross section showing the terminal connecting part of the motor. FIG. 11B is an enlarged cross section showing a state where a terminal is connected to the terminal connecting part. FIG. 11C is a partial plan view of the motor with the terminal connected. FIG. 12 is a cross section taken along line Y-Y of FIG. 2. FIG. 13 is an enlarged cross section of the Z part in FIG. 12. FIG. 14A illustrates the relationship between an output shaft and a stopper element used in the steering lock device and the stopper of the cover. FIG. 14B is a cross section taken along line P-P of FIG. 14A. FIG. 15A is a cross section of the tip of the output shaft. FIG. 15B is a side view of the tip of the output shaft. FIG. 16A is a plan view of the stopper element. FIG. 16B is a cross section taken along line Q-Q of FIG. 16A. FIG. 17A is a bottom view of the main part of the cover. FIG. 17B is a cross section taken along line R-R of FIG. 17A. FIG. 18A is a side view of the lower end of the output shaft. FIG. 18B is a bottom view of the lower end of the output shaft. FIGS. 19 through 23 illustrate step by step the relationship between the rotation of the output shaft and the operation of the limit switch.

As shown in FIGS. 1 through 6, a steering lock device (actuator device) 10 includes a box-shaped case 11 made of a synthetic resin having a motor housing unit 11a and a gear housing unit 11b in communication with the motor housing unit 11a and a cover 12 made of a synthetic resin clamped and fixed with a screw 15 so as to cover the motor housing unit 11a and the gear housing unit 11b of the case 11. A motor 20 is accommodated in the motor housing 11a of the case 11. The tip 21a of its armature shaft (drive shaft) 21 is rotatably supported by a bearing 17 held by the bearing holding part 11d of the gear housing unit 11b. Into the small diameter part 17a of the bearing 17 is fitted a rubber O-ring (vibration-proof member) 18. By the bearing 17 and the rubber O-ring 18 is supported the tip 21a of the armature shaft 21 of the motor 20 on the bearing holding part 11d of the gear housing unit 11b in a floatable fashion. A worm 21b formed at the tip of the armature shaft 21 comes into the gear housing unit 11b. When an electric current is supplied to the armature coil of an armature (not shown) mounted on the armature shaft 21, the armature is normally rotated or inversely rotated. When the electric current supplied to the armature coil is shut off, an electromagnetic control circuit is formed to cause an electromagnetic control current to flow in the armature coil.

As shown in FIGS. 1 and 6, above both sides of both mutually facing side walls 11e of the motor housing unit 11a of the case 11 (in the proximity of each corner) is integrally protruded a pair of projections 11f, 11f extending in parallel in vertical direction. Above the bottom wall 11c in the motor housing unit 11a is integrally protruded a pair of projections 11g, 11g extending widthwise in parallel, as shown in FIG. 7. On each projection 11f, 11g of the motor housing unit 11a is supported a motor 20 via an elastic member 22 attached to the motor 20 in a floatable fashion. Into the bearings 20a, 20b before and after the motor 20 are fitted rubber O-rings 20c, 20d. Via these O-rings 20c, 20d, the bearings 20a, 20b are respectively supported by the bearing holding parts 16a, 16b of the case 11. The motor 20 is supported before and after the motor housing unit 11a in a floatable fashion. That is, the motor 20 housed in the motor housing unit 11a is supported on the case 11 by the elastic member 22 and the O-rings 20c, 20d in a floatable fashion.

As shown in FIGS. 6 through 10, the elastic member 22 is formed cylindrically of a thermoplastic elastomer resin material. That is, the elastic member 22 is formed cylindrically by an upper wall (upper part) 22a, both side walls 22b, 22b, and a bottom wall (bottom part) 22c. Above each of the external surface of the upper wall 22a and the bottom wall 22c is integrally protruded a pair of projections 22d, 22d extended in parallel in the longitudinal direction. The pairs of projections 22d, 22d are arranged to intersect the pair of projections 11g, 11g of the bottom wall 11c of the motor housing unit 11a and the pair of projections 12g, 12g integrally protruded above the inner surface 12a of the cover 12, respectively. This supports the motor 20 in a floatable fashion between the pair of projections 11g, 11g of the bottom wall 11c of the motor housing unit 11a and the pair of projections 12g, 12g of the inner surface 12a of the cover 12 via the pair of projections 22d, 22d of the upper wall 22a of the elastic member 22 and the pair of projections 22d, 22d of the bottom wall 22c.

Behind the upper wall 22a of the elastic member 22 is extending a terminal catch 22e. The terminal catch 22e is intended to catch an L-shaped terminal 24 inserted so as to come into contact with a terminal connecting piece 23 in the form of an approximately Z-shaped metal plate arranged in the hole 20e in the motor 20, as shown in FIGS. 9 and 11. A core 25a of a harness 25 is sandwiched by the approximately V-shaped part of one end of the terminal 24 while being soldered thereto. As shown in FIGS. 6 through 10, at each of the upper and lower parts of the side walls 22b, 22b of the elastic member 22 is integrally protruded a pair of harnesses sandwiching parts 22f, 22f.

As shown in FIGS. 1, 6, 7 and 12, in the gear housing unit 11b of the case 11 are rotatably housed a deceleration gear 26 made of a synthetic resin driven to rotate by the armature shaft 21 of the motor 20 and an output gear 28 made of a synthetic resin driven to rotate via the deceleration gear 26. The deceleration gear 26 includes a large gear 26b engaged with the worm 21b of the armature shaft 21 of the motor 20 and a small gear 26c engaged with the output gear 28. In the center of the deceleration gear 26 is formed a round hole 26a, in which a spindle 27 is penetrated. As shown in FIG. 12, the upper and lower end of the spindle 27 are fitted to the recessed part 11h of the bottom wall 11c of the case 11 and the recessed part 12h of the inner surface of the cover 12. The deceleration gear 26 is rotatably supported via the spindle 27.

As shown in FIGS. 1, 6 and 12, inside the cylindrical gear main body 28a of the output gear 28 is integrally formed a cylindrical output shaft 29 made of a metal by insert molding. The lower end of the small diameter of the output shaft 29 is rotatably supported by a bearing 19 fitted to the bottom wall 11c of the case 11. The upper end 29a of the small diameter of the output shaft 29 is rotatably supported by a bearing 12b formed on the cover 12. This allows the output gear 28 and the output shaft 29 to rotate together. At the lower end of the gear main body 28a of the output gear 28 is integrally protruded a cam part 28c. Inside the gear housing unit 11b of the case 11 facing the cam part 28c is mounded, via a switch holder 36 made of a synthetic resin and a screw 37, a pair of limit switches (switch means) 35, 35 turned on/off by the cam part 28c. To each limit switch 35 is connected a pair of harnesses 38, 38, as shown in FIGS. 2, 3, 4 and 6.

As shown in FIGS. 1, 6, 12 and 14, on the top surface 28d of the output gear 28 is formed a ring-shaped receiving recessed part 28e rotatably accommodating a stopper element 30 formed of a sintered metal. Below the upper end 29a of the output shaft 29 facing the inside of the receiving recessed part 28e is integrally protruded a projection part 29c. As shown in FIG. 16, the stopper element 30 is formed an approximate disc having a cylindrical part 30a in its center. The stopper element 30 has the inner peripheral surface 30b of the cylindrical part 30a fitted to a large intermediate shaft 29g of the output shaft 29. The stopper element 30 is rotatably mounted on the output shaft 29. Above the inner peripheral surface 30b of the cylindrical part 30a is integrally protruded a locking projection part 30c that is locked to and separated from the projection part 29c of the output shaft 29. Above the top surface 30d of the stopper element 30 is integrally protruded a pair of stoppers 31, 31, apart by 180 degrees, that is brought into contact with and locked to each stopper 13 of the cover 12 mentioned later.

As shown in FIGS. 12 through 14 and FIG. 17, above the inner surface 12a of the cover 12 are integrally protruded, at predetermined intervals on the same perimeter, four stoppers 13 for limiting the rotation angle of the output gear 28 so as to allow the output gear 28 to rotate by a predetermined angle. As shown in FIGS. 14 and 19, at a certain point in time during rotation of the output gear 28 and the output haft 29, the projection part 29c of the output shaft 29 and the locking projection part 30c of the stopper element 30 are aligned on a straight line. In the center between the left and right pairs of stoppers 13, 13 located on the upper and lower part of the inner surface 12a of the cover 12 is respectively positioned each stopper 31 of the stopper element 30 accommodated in the receiving recessed part 28e of the output gear 28. Each stopper 13 protruded above the inner surface 12a of the cover 12 is arranged to protrude into the receiving recessed part 28e of the output gear 28 so as to be accommodated in the receiving recessed part 28e. Between the bottom surface of the receiving recessed part 28e of the output gear 28 and the bottom surface of the stopper element 30 are interposed a curve washer (bent washer) 33 and a pair of flat washers 34, 34 sandwiching the curve washer 33. The elastic force of the curve washer 33 constantly energizes the stopper element 30 toward the inner surface 12a of the cover 12.

As shown in FIGS. 12 and 13, on the outside of each stopper 13 of the inner surface 12a of the cover 12 is protruded in a ring shape a projection part 12c extending so as to surround a peripheral wall 28f forming the receiving recessed part 28e of the output gear 28.

As shown in FIGS. 12 and 18, at the lower end 29b of the output shaft 29 exposed outside the bottom wall 11c of the case 11 are formed a stopping D-cut part 29d and a backlash preventive serration part 29e. In the center of the output shaft 29 is formed a screw hole 29f. To the lower end 29b of the output shaft 29 is clamped and fixed an output cam (output member) 40 used to lock/unlock a steering shaft (not shown) via a screw 41.

According to the steering lock device 10 of Embodiment 1, when an electric current is supplied to the armature coil (not shown) of the motor 20, the worm 21b of the armature shaft 21 rotates and the output gear 28 rotates via the deceleration gear 26. With the rotation of the output gear 28, the output shaft 29 rotates.

As shown in FIGS. 14A, 14B and 19A, When the output gear 28 and the output shaft 29 rotate by a predetermined angle in the arrow direction shown in FIGS. 19A and 20A from a state where each stopper 31 of the stopper element 30 accommodated in the receiving recessed part 28e of the output gear 28 is apart from each stopper 13 of the cover 12, the cam part 28c integrally protruded above the gear main body 28a of the output gear 28 pushes the operation lever 35a of one limit switch 35 in the OFF state arranged at the corner of the gear housing unit 11b of the case thereby turning ON the limit switch 35, as shown in FIG. 20B.

When the limit switch 35 is turned ON, a position detection signal is output to the motor 20 and energization is turned OFF and the current supplied to the armature coil is shut off. After the limit switch 35 is turned ON, as shown in FIG. 21A, the output gear 28 and the output shaft 29 further rotate by way of delay and coasting. In this practice, incase, for example, the supply voltage is high or atmospheric temperature is high, overrun caused by a delay or coating becomes greater. Thus, even after the limit switch 35 is turned ON, the output gear 28 and the output shaft 29 further rotate in the arrow direction, as shown in FIG. 22A.

With the rotation of the output gear 28 and the output shaft 29, as shown in FIG. 22A, the projection part 29c of the output shaft 29 pushes the locking projection part 30c of the stopper element 30 accommodated in the receiving recessed part 28e of the output gear 28. This causes the stopper element 30 in the receiving recessed part 28e of the output gear 28 to rotate in the arrow direction as shown in FIG. 22A and causes the pair of stoppers 31, 31 of the stopper element 30 to be brought into contact with and locked to the opposed pair of stoppers 13, 13 of the cover 12, as shown in FIG. 23A. At this point in time, the output gear 28 and the output shaft 29 stop rotating. The position the output gear 28 halts is where the cam part 28c can keep the limit switch 35 ON.

In this way, by causing the pair of stoppers 31, 31 accommodated in the receiving recessed part 28e of the output gear 28 to be brought into contact with and locked to the pair of stoppers 13, 13 of the cover 12 protruding while being accommodated in the receiving recessed part 28e, it is possible to rotate the output gear 28 within a predetermined angle and stopping the same on any occasion. With this configuration, it is possible to disperse by half the impact at the contact locking of the pair of stoppers 13, 13 of the cover 12 and the pair of stoppers 31, 31 of the stopper element 30, compared with a case where a single projection is provided on each of the output gear and the cover as in the related art. This reliably prevents possible deformation and breakage of the cover 12 such as floating of the cover 12. Unlike the relate art practices, it is not necessary to mount a load-absorbing elastic element on the projection of the cover, thereby reducing the number of parts required as well as the overall cost.

It is possible to reliably absorb the impact at the contact locking of the pair of stoppers 13, 13 of the cover 12 and the pair of stoppers 31, 31 of the stopper element 30 in balance by way of the pair of stoppers 13, 13 of the cover 12 and the pair of stoppers 31, 31 of the stopper element 30. This reliably suppresses possible deformation of the cover 12 such as warpage and reliably rotates the output gear 28 within a predetermined angle and stopping the same on any occasion.

It is possible to accommodate each stopper 12 of the stopper element 30 and the cover 12 in the receiving recessed part 28e of the output gear 28. This provides a more compact and lower-profile design of the entire steering lock device 10. It is also possible to set at a wide angle the receiving recessed part 28e of the output gear 28 where the stopper element 30 is accommodated. This allows use of the stopper element 30 having a sufficient volume (length in the perimeter direction). In other words, it is possible to provide a stopper structure having certain strength within the small-space receiving recessed part 28e of the output gear 28 while securing the operation angle and capacity of each stopper 31 of the stopper element 30.

Further, the cam part 28c is integrally protruded above the gear main body 28a of the output gear 28 accommodating the stopper element 30 that reliably stops rotation of the output gear 28 and the output shaft 29 by way of each stopper 31. This configuration reliably prevents a phenomenon where the cam part 28c slides over the operation lever 35a of the limit switch 35. It is possible to reliably turn on/off the limit switch 35 by using the cam part 28c.

While a pair of stoppers of the stopper element is directly brought into contact with four stoppers of the cover without attaching a damper in Embodiment 1, it is possible to apply Embodiment 1 to a case where a rubber damper is attached to each of the four stoppers of the cover in order to use two stoppers facing each other out of the four stoppers to push the thick part of the damper. While the elastic member is a thermoplastic elastomer resin material in Embodiment 1, a member of another material, such as a rubber, may be used instead. While a rubber O-ring is used as a vibration-proof member in the embodiment, the invention is not limited thereto.

What is claimed is:

1. An actuator device comprising:
a case having a cover that covers a motor housing unit and a gear housing unit;
a motor housed in the motor housing unit of the case;
an output gear rotatably housed in the gear housing unit of the case, the output gear driven to rotate via a deceleration gear by the driving shaft of the motor;
an output shaft rotatably supported by the case and rotating together with the output gear; and
an output member mounted on the output shaft;
a stopper element rotatably mounted on the output shaft;
a stopper where the stopper element is locked to the inner surface of the cover to limit the rotation angle of the output gear;
a receiving recessed part for receiving the stopper element formed on the top surface of the output gear; and
a projection formed on the output shaft facing the inside of the receiving recessed part, wherein
the stopper element is respectively provided with a locking projection part that is locked to and separated from the projection of the output shaft and at least a pair of stoppers, and
at least a pair of stoppers are provided on the inner surface of the cover where each stopper of the stopper element is brought into contact with and locked to the output gear in order to limit the rotation angle of the output gear.

2. The actuator device according to claim 1, wherein
the stopper element is formed in the shape of an approximate disc having a cylindrical part in the center thereof,
the locking projection part is integrally protruded above the inner peripheral surface of the cylindrical part of the stopper, and
at least the pair of stoppers is integrally protruded above the top surface of the stopper element.
